(19) United States
(12) Patent Application Publication
(10) Pub. No.: US 2026/0162080 A1
(43) Pub. Date: Jun. 11, 2026

(54) METHOD AND ELECTRONIC DEVICE FOR PROVIDING SOCIAL NETWORKING SERVICE ACCOUNT OPERATION AND MANAGEMENT SERVICE

(71) Applicants: Hangzhou Alibaba International Internet Industry Co., Ltd., Hangzhou (CN); Alibaba Singapore Holding Private Limited, Singapore (SG)

(72) Inventors: Yuke ZHANG, Hangzhou (CN); Hua GU, Hangzhou (CN); Yao SONG, Hangzhou (CN); Ting LI, Hangzhou (CN)

(21) Appl. No.: 19/407,040

(22) Filed: Dec. 3, 2025

(30) Foreign Application Priority Data
Dec. 5, 2024 (CN) 202411783818.5

(51) Int. Cl. G06Q 50/00; G06Q 30/0601

(52) U.S. Cl. CPC G06Q 10/40; G06Q 30/0631

(57) ABSTRACT

An embodiment of the present application discloses a method for providing a Social Networking Service account operation and management service comprising: constructing a Social Networking Service (SNS) account matrix system of a target entity, wherein the account matrix system comprises a main account registered by the target entity in an SNS network, a plurality of country/region accounts respectively registered for a plurality of different countries/regions, and at least one sub-account associated under each country/region account, wherein the sub-account has its own respective account persona positioning directed to a specific segmented population, industry, and/or commodity category; performing automated content generation and publishing through an Artificial Intelligence (AI) large model according to a content publishing strategy corresponding to an account in the account matrix system; wherein, the content publishing strategy corresponding to the sub-account is related to the account persona positioning of the account.

### CROSS-REFERENCE TO RELATED APPLICATIONS

This application claims priority to Chinese Patent Application No. 202411783818.5, filed with the China National Intellectual Property Administration on Dec. 5, 2024, and entitled “METHOD AND ELECTRONIC DEVICE FOR PROVIDING SOCIAL NETWORKING SERVICE ACCOUNT OPERATION AND MANAGEMENT SERVICE,” which is incorporated herein by reference in its entirety.

### TECHNICAL FIELD

The present application relates to the field of information processing technology, and, in particular, to a method and electronic device for providing a Social Networking Service account operation and management service.

### BACKGROUND

Social Networking Service (SNS) operation has become an indispensable part of modern corporate marketing strategies. By managing and optimizing their online accounts through social media platforms and publishing content such as online posts, enterprises can increase brand exposure, enhance user interaction rates, and improve website traffic. In the current fiercely competitive market environment, a successful SNS operation strategy can not only win more consumer attention for an enterprise but also enhance the brand's competitive advantage.

The core of SNS operation lies in enhancing brand influence, increasing user engagement, and driving traffic through effective content management and user interaction. With the rapid development of social media, enterprises are placing increasing importance on SNS operation, which provides broad development space and market demand for the innovation of related technologies and methods.

To meet the SNS operation needs of enterprises, some products or tools can provide enterprises with comprehensive social media content management functions, including, for example, title optimization, lists of potential blockbuster topics, rewriting of popular post content, text polishing, and suggestions for optimal publishing times, to help enterprises improve the quality of social media interaction, or to help enterprises increase the exposure rate and interaction of their posts, and so on.

However, during the SNS operation process, user interaction often exhibits distinct localization characteristics. If an enterprise or platform only targets users within a certain country, since the enterprise is usually very familiar with the culture of that country, and users may also be very familiar with such an enterprise or platform, the operating personnel of the enterprise or platform usually know very clearly what content is likely to attract users'attention, and so on. Therefore, on this basis, it is usually feasible to further combine the use of the aforementioned content optimization-related products or tools to improve content quality. However, there are also some enterprises or platforms that may be involved in cross-border trade. In this case, it may be necessary to conduct cross-border SNS operations targeting users in multiple different countries or regions. Different countries/regions have different cultures, and the hot topics that users in different countries/regions pay attention to may all be different. Users in other countries/regions may not be particularly familiar with specific enterprises/platforms, and there are also differences in language, time zones, and so on. It can be seen that the difficulty of SNS operation in cross-border scenarios is considerable. In the prior art, it is usually necessary for enterprises/platforms to deploy local operating personnel in different countries/regions respectively. Such operating personnel need to be very familiar with the local cultural background, have keen insight into hot current events, and possess good content creation capabilities, etc., which results in very high operating costs.

### SUMMARY

The present application provides a method for providing a Social Networking Service account operation and management service and an electronic device, which can improve the effect of account operation in cross-border scenarios and reduce operating costs.

The present application provides the following solutions:

A method for providing a Social Networking Service account operation and management service, applied to an account operation and management service system, the method comprising:
determining a Social Networking Service (SNS) account matrix system of a target entity, wherein the account matrix system includes a main account registered by the target entity in an SNS network, a plurality of country/region accounts registered respectively for a plurality of different countries/regions, and at least one sub-account associated with each country/region account, wherein the sub-account includes an account registered by the target entity in the SNS network, and/or, an account registered by another entity in the SNS network and authorized to the target entity for operational management and hosting; wherein the sub-account has its own account persona positioning in terms of targeting a specific segmented population, industry, and/or commodity category;
performing automated content generation and publishing through an Artificial Intelligence (AI) large model according to a content publishing strategy corresponding to an account in the account matrix system; wherein the content publishing strategy corresponding to the sub-account is related to the account persona positioning of the account.

Specifically, performing content generation for the sub-account through the AI large model comprises:
collecting hot topic data;
understanding the hot topic data through an AI large model for decision-making to determine a suitable content type, as well as a suitable country/region, target population, industry, and/or commodity category, and determining at least one target sub-account related to the target country/region, target population, industry, and/or commodity category;
generating content of a corresponding type for the target sub-account by an AI large model pre-trained for the target sub-account, and determining a publishing time according to a corresponding publishing time strategy.

Specifically, the target entity includes a cross-border commodity information service platform;
the content type includes a product recommendation type;
the method further comprises:
determining a target commodity related to the hot topic data from the commodity information service platform, and relevant display materials of the target commodity;
providing the relevant display materials of the target commodity to the AI large model trained for the target sub-account, for use in generating text content related to product recommendation based on the hot topic data, and assembling it with the display materials into content to be published of the product recommendation type.

Specifically, performing content generation for the sub-account through the AI large model further comprises:
after generating the content of the corresponding type for the target sub-account, performing adaptation processing on the generated content for the SNS network corresponding to the target sub-account, with respect to the content style, format, specifications, required interactive elements, and/or user preferences of the SNS network.

Specifically, when performing the adaptation processing, if the SNS network supports a plurality of different content formats, rewriting the generated content in a plurality of ways to generate content corresponding to the plurality of content formats, and publishing the content in the different content formats respectively.

Specifically, the method further comprises:
updating the content publishing strategy corresponding to the sub-account based on user interaction feedback on the content published in the account.

Specifically, the method further comprises:
performing collaborative interaction processing between different accounts in the account matrix system through the AI large model.

Specifically, performing the collaborative interaction processing between different accounts in the account matrix system comprises:
judging a quality of the content generated by the AI large model for the sub-account, and if a preset condition is met, mentioning the country/region account of the country/region to which the sub-account belongs and/or the main account in the generated content, to achieve interaction between the sub-account and the country/region account and/or the main account.

Specifically, performing the collaborative interaction processing between different accounts in the account matrix system comprises:
reposting, by the sub-account, a portion of content published by the country/region account of the country/region to which it belongs.

Specifically, performing the collaborative interaction processing between different accounts in the account matrix system comprises:
performing mutual following between sub-accounts with the same or related account persona positioning, and/or mutually reposting content published by each other.

Specifically, the method further comprises:
after an account in the account matrix system receives comment content or private message content input by a user for published content, using the AI large model to generate reply content for the comment content or private message content.

Specifically, the method further comprises:
following, by a sub-account in the account matrix system, a well-known account outside the system in a corresponding industry or field, and after the well-known account outside the system publishes content, using the AI large model to generate comment content for the published content.

Specifically, the method further comprises:
by setting a keyword and/or topic monitoring mechanism, capturing and analyzing in real time hot topics and/or discussion trend content in the SNS network, and determining a sub-account in the account matrix system that is related to the hot topics and/or discussion trend content, and generating, through the AI large model, content for the sub-account to comment on the hot topics and/or discussion trend content.

An SNS account information processing method, comprising:
receiving, through a target interface, account configuration information submitted for a target entity, wherein the account configuration information includes a main account registered by the target entity in an SNS network, a plurality of country/region accounts registered respectively for a plurality of different countries/regions, and at least one sub-account associated with each country/region account, wherein the sub-account includes an account registered by the target entity in the SNS network, and/or, an account registered by another entity in the SNS network and authorized to the target entity for operational management and hosting; wherein the sub-account has its own account persona positioning in terms of targeting a specific segmented population, industry, and/or commodity category;
constructing an SNS account matrix system of the target entity based on the account configuration information, so as to perform automated content generation and publishing through an AI large model according to a content publishing strategy corresponding to an account in the account matrix system; wherein the content publishing strategy corresponding to the sub-account is related to the account persona positioning of the account.

Specifically, the AI large model is also used for performing collaborative interaction processing between different accounts.

A computer-readable storage medium, on which a computer program is stored, wherein when the program is executed by a processor, the steps of the method according to any one of the preceding items are implemented.

An electronic device, comprising:
one or more processors; and
a memory associated with the one or more processors, the memory being configured to store program instructions, wherein when the program instructions are read and executed by the one or more processors, the steps of the method according to any one of the preceding items are performed.

A computer program product, comprising a computer program/computer-executable instructions, wherein when the computer program/computer-executable instructions are executed by a processor in an electronic device, the steps of the method according to any one of the preceding items are implemented.

According to specific embodiments provided by the present application, the present application discloses the following technical effects:

Through the embodiments of the present application, an account operation and management service can be provided for entities with cross-border account operations. Through this service, an SNS account matrix system can be constructed for a specific entity. The matrix can include a main account registered by the entity in an SNS network, and can also include country/region accounts registered for multiple countries/regions. Each country/region account can also have at least one sub-account. Such a sub-account can be an account directly registered by the current entity in the SNS network, or it can be an account registered by another entity in the SNS network and authorized to the current entity for operation hosting; wherein, such a sub-account has its own account persona positioning in terms of targeting a specific segmented population, industry, and/or commodity category. On the basis of constructing the above-mentioned account matrix system, automated content generation and publishing can also be performed through an Artificial Intelligence (AI) large model according to a content publishing strategy corresponding to an account in the account matrix system; wherein, the content publishing strategy corresponding to the sub-account can be related to the account persona positioning of the account, so that the content, time, etc., published by a specific sub-account are all related to the specific account persona positioning, achieving refined operation for each user group, and enabling the same sub-account to gain continuous attention from the corresponding population.

In an optional implementation, collaborative interaction processing can also be performed between different accounts in the account matrix system through the AI large model, including mentioning the country/region account of the country/region to which the sub-account belongs and/or the main account in the content generated for the sub-account; or, reposting a portion of the content published by the country/region account of the country/region to which the sub-account belongs; or, performing mutual following between sub-accounts with the same or related account persona positioning, and/or mutually reposting content published by each other, and so on. Through this kind of interaction between accounts, an effect of widely displaying the brand image to users can be formed, reducing account operating costs.

In addition, intelligent replies can also be implemented through the AI large model, including replying to users' comment or private message content, or intelligently replying to content published by popular accounts in the industry, or, by setting a keyword and/or topic monitoring mechanism, capturing and analyzing in real time hot topics and/or discussion trend content in the SNS network, and determining a sub-account in the account matrix system that is related to the hot topics and/or discussion trend content, and generating, through the AI large model, content for the sub-account to comment on the hot topics and/or discussion trend content.

Certainly, any product implementing the present application does not necessarily need to achieve all the advantages described above at the same time.

### BRIEF DESCRIPTION OF DRAWINGS

To more clearly illustrate the technical solutions in the embodiments of the present application or in the prior art, the drawings required for use in the embodiments will be briefly introduced below. It is obvious that the drawings in the following description are only some embodiments of the present application, and for those of ordinary skill in the art, other drawings can be obtained based on these drawings without creative labor.

FIG. 1 is a schematic diagram of a system architecture provided by an embodiment of the present application;

FIG. 2 is a flowchart of a first method provided by an embodiment of the present application;

FIG. 3 is a schematic diagram of an account matrix system provided by an embodiment of the present application;

FIG. 4 is a flowchart of a second method provided by an embodiment of the present application;

FIG. 5 is a schematic diagram of an electronic device provided by an embodiment of the present application.

### DETAILED DESCRIPTION

The technical solutions in the embodiments of the present application will be clearly and completely described below in conjunction with the drawings in the embodiments of the present application. Obviously, the described embodiments are only a part of the embodiments of the present application, not all of the embodiments. Based on the embodiments in the present application, all other embodiments obtained by those of ordinary skill in the art without creative labor shall fall within the protection scope of the present application.

First, it should be noted that in cross-border trade scenarios, both platform parties (platforms that provide commodity information services, generally can be called e-commerce platforms, etc.) and specific merchants and other enterprise parties will face the problem that foreign users may not be very familiar with the platform or enterprise. If a platform party needs to carry out some large-scale marketing activities, or an enterprise needs to enhance its brand awareness, etc., then using SNS accounts for related publicity is an important way to effectively reach consumers with relevant information, achieve more interaction with users, and thus drive traffic to the platform or specific brand stores. In the prior art, in order to achieve the above objectives, the purpose of attracting users is usually achieved by optimizing the quality of the published content. However, because the cultures of different countries/regions can be very different, to carry out differentiated account operations in multiple different countries and achieve the purpose of publicity, one often faces huge operating costs.

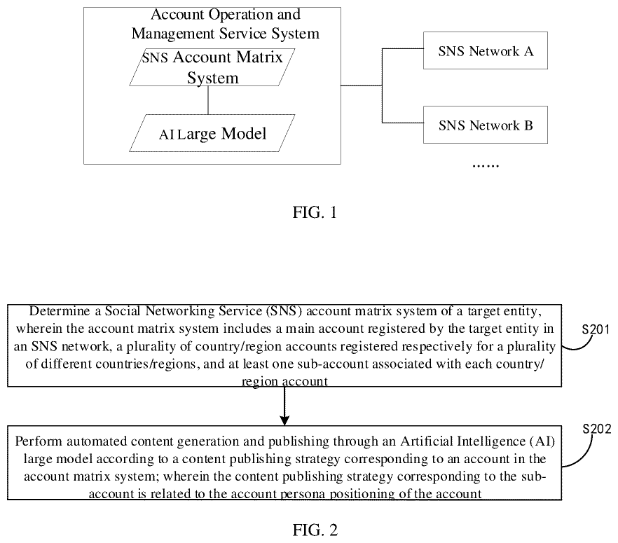

In an embodiment of the present application, in order to help relevant platform parties or enterprise parties conduct SNS account operations in cross-border trade scenarios, referring to FIG. 1, an account operation and management service system can be provided, which is used to provide SNS operation and management services for specific entities (for example, including e-commerce platforms or enterprises, etc.), that is, to help entities achieve SNS account management in cross-border commodity trade scenarios. Specifically, first, an SNS account matrix system can be created for a specific platform or enterprise in this service, establishing a three-tier “main account-country account-sub-account” account matrix operation system. This allows for an increase in the refinement of operations at the country dimension. Sub-accounts can also have their own persona positioning, for example, targeting a certain segmented population, industry, commodity category, etc., so that through such sub-accounts, populations in more vertical domains can be targeted, expanding the user reach area of followers (commonly known as “fans,” etc.). That is to say, through such sub-accounts, refined operation for each segmented population can be achieved. A sub-account can only publish content that users in that segmented population want to see, rather than publishing divergently, so that each sub-account can maintain a specific group of followers (fans) (otherwise, if an account publishes all kinds of content, it may lead to different groups of people liking different content from the same account, and among them, some people's attention to the account will decrease, because they may think that the account cannot be the source of information they need).

Taking a specific entity being an e-commerce platform as an example, in the above-mentioned three-tier account matrix operation system, the SNS main account of the platform can first be determined. Then, the same platform can also be associated with multiple country/region accounts for publishing content to users in specific countries/regions. Furthermore, multiple sub-accounts can also be associated under a specific country/region account. These sub-accounts can be multiple secondary accounts (colloquially, “smurf accounts”) registered by the platform party itself, or, in an embodiment of the present application, they can also be SNS accounts registered by some merchants, but which can be authorized to the platform for operation, and so on. That is to say, a sub-account can be an SNS account registered by the current entity itself, or it can be an SNS account registered by another entity but authorized to the current entity. In particular, regardless of whether it is registered by the current entity or registered by another entity and authorized to the current entity for operation, these sub-accounts can have their own account persona positioning, that is, a specific sub-account can be oriented towards a segmented population in a certain vertical domain, or a specific industry and/or a specific commodity category. Correspondingly, the content published by these sub-accounts can also correspond to their persona positioning.

In particular, since there may be multiple SNS networks, the same entity may also have multiple main accounts, corresponding to multiple different SNS networks. Correspondingly, the same entity may also have multiple middle-tier accounts in the same country/region, corresponding to different SNS networks. Sub-accounts are similar; for the same segmented population or the same industry, category, etc., there can be different sub-accounts in different SNS networks respectively. This makes the number of accounts for the same entity in the above-mentioned three-tier account matrix operation system very large. Moreover, in order to achieve more refined operations, the content, timing, etc., of publications for different accounts may need to be different. Therefore, if the method in the prior art is still followed, where specific operating personnel edit the content to be published for each account, the workload would be enormous, and even an impossible task.

Therefore, in an embodiment of the present application, on the basis of the above-mentioned three-tier account matrix system, a solution for achieving automated operation of the above-mentioned accounts based on an AI (Artificial Intelligence) large model is proposed. In particular, the so-called AI large model usually refers to a deep learning model containing massive parameters. Due to its huge scale, this kind of AI large model can store and process a large amount of information, thereby achieving higher performance on various tasks. Therefore, relying on the powerful natural language text understanding, logical thinking, and content generation capabilities of a pre-trained large AI model, intelligent account operations in the embodiments of the present application can be realized. Specifically, automated content generation and publishing can be performed through the AI large model according to a content publishing strategy corresponding to a specific account. This content publishing strategy can be related to the account persona positioning of the specific account, that is, it is necessary to generate content suitable for the different persona positionings of different accounts. Automated processing of publishing time, language, etc., can also be achieved based on the country/region to which the specific account belongs. It should be noted here that, in specific implementation, the AI large model can mainly generate specific content for sub-accounts, while the content published by main accounts, country/region accounts, etc., usually has certain characteristics of authority, or represents the image of a specific platform or brand in a specific country/region. The specific content published needs to be more cautious, and the number of main accounts and country/region accounts is not particularly large. Therefore, it can be generated by manual means, or, it can be published after manual review on the basis of AI generation, and so on.

In addition, the collaborative relationship between different accounts can also be managed through the AI large model to achieve mutual traffic diversion between different accounts. For example, after the AI large model generates specific content for a certain sub-account, if the quality of the specific content is relatively high, traffic can be diverted to the country/region account or the main account by mentioning the specific country/region account or the main account in the specific content. Alternatively, after the main account or country/region account publishes certain content, it can be reposted by sub-accounts, so that the content published by the main account or country/region account can more effectively reach a certain segmented population through these sub-accounts, and so on.

In practical applications, in addition to intelligently generating and publishing specific content through the AI large model, intelligent reply content can also be generated through the AI large model. For example, when a user posts comment content on the content published by an account, intelligent reply content can be generated through the AI large model. Or, after a user sends private message content to an account, intelligent reply content can also be generated through the AI large model, and so on.

The specific implementation solutions provided by the embodiments of the present application are described in detail below.

### Embodiment One

First, Embodiment One of the present application provides a method for providing a Social Networking Service account operation and management service. The method is applied to an account operation and management service system. Specifically, referring to FIG. 2, the method may include:
S201: Determine a Social Networking Service (SNS) account matrix system of a target entity, wherein the account matrix system includes a main account registered by the target entity in an SNS network, a plurality of country/region accounts registered respectively for a plurality of different countries/regions, and at least one sub-account associated with each country/region account, wherein the sub-account includes an account registered by the target entity in the SNS network, and/or, an account registered by another entity in the SNS network and authorized to the target entity for operational management and hosting; wherein the sub-account has its own account persona positioning in terms of targeting a specific segmented population, industry, and/or commodity category.

When providing an account operation service through the solution provided by this embodiment of the present application, an SNS account matrix system can first be constructed for a specific target entity. In particular, the specific target entity is an entity with account operation needs, which can specifically be an e-commerce platform, or a merchant on an e-commerce platform, or other enterprise parties, and so on.

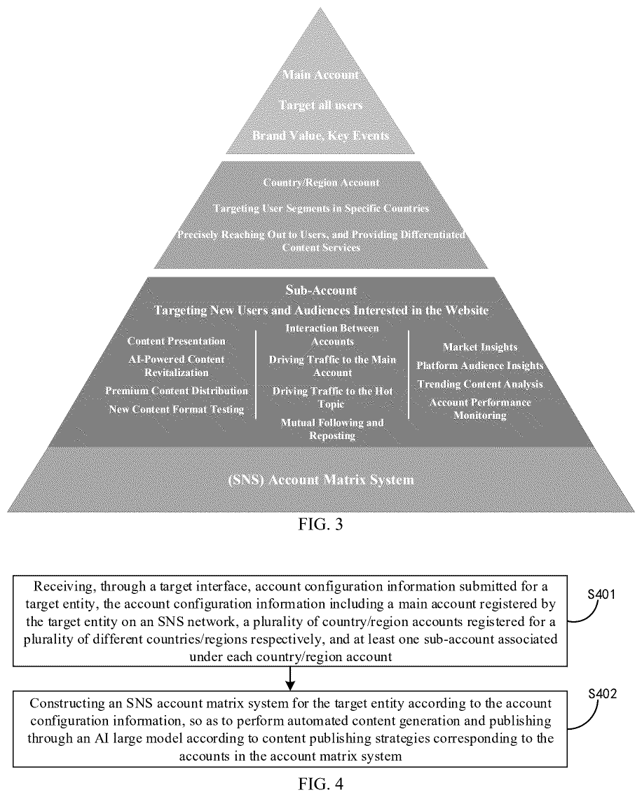

Regarding the SNS account matrix system, it can specifically be the aforementioned three-tier account matrix system. As shown in FIG. 3, the first tier can be the main account, the middle tier can be the country/region accounts, and the third tier is the sub-accounts, which can be some accounts registered by the current entity itself, or, they can be accounts registered by other entities and authorized to the current entity for operation. Certainly, regardless of whether they are registered by the current entity or by other entities, such sub-accounts can have their own account persona positioning, for example, targeting a segmented population in a certain vertical domain, or a certain industry, a certain commodity category, etc.

In particular, since there are usually multiple types of SNS networks, the same entity can have multiple different main accounts, corresponding to multiple different SNS networks. In addition, the same entity can also open country/region accounts in multiple different SNS networks in the same country/region. For example, assuming there are a total of M SNS networks and a total of N countries/regions, then one entity can correspond to a maximum of M×N country/region accounts. Certainly, in practical applications, one can also choose to open country/region accounts only in some SNS networks and some countries/regions, and so on. Regarding sub-accounts, each country/region account can have multiple different sub-accounts to achieve different refined operations for multiple different segmented populations within the same country/region.

In particular, in specific implementation, an interface can be provided for users (who can be operating personnel of a certain entity, etc.) to configure account information for the target entity. In this way, the user can prepare various accounts in advance and input the specific information of various accounts through this interface, for example, what the main account of a certain target entity is, what the respective country/region accounts for each country/region are, and which sub-accounts are under each country/region account, and so on.
S202: Perform automated content generation and publishing through an Artificial Intelligence (AI) large model according to a content publishing strategy corresponding to an account in the account matrix system; wherein the content publishing strategy corresponding to the sub-account is related to the account persona positioning of the account.

After constructing the three-tier account matrix system, because the number of accounts in the matrix is very large, and different accounts may have their own different account persona positionings, including corresponding to different countries/regions, targeting segmented populations, industries, categories, etc., in different vertical domains, when publishing content through specific accounts, it is necessary to generate different content for different accounts respectively to conform to the settings of their respective persona positionings. Based on the above situation, this embodiment of the present application provides an implementation method of generating and publishing content for specific accounts through an AI large model.

Specifically, when generating content for the authorized sub-account through the AI large model, hot topic data can first be collected, and specific content generation can be based on this hot topic data. In particular, the specific collection of hot topic data can be achieved through multiple methods. For example, when the target entity is an e-commerce platform, on-site hot topic data of the e-commerce platform system can be collected, and off-site hot topic data can also be collected, and so on. In particular, for on-site hot topic data, that is, the on-site hot topic data of the e-commerce platform, one can specifically collect user hot search terms, new and popular products, and popular sales activities (such as large-scale promotional activities, etc.), and can also select well-performing creatives from external advertising creatives, and so on. For off-site hot topic data, one can collect various data such as popular SNS posts, hot-selling lists on other e-commerce platforms, and holiday information by connecting with third-party tools.

During the process of real-time hot topic data capture, simply generating content based on the current hot topic data may lead to a series of problems, for example, negative hot topic information is not suitable for posting, fatigue from similar hot topics, and inconsistency between the hot topic and the positioning of the current entity, etc. The existence of these problems may lead to a decline in user interest in the content, thereby affecting the overall effectiveness of the platform.

Therefore, in practical applications, after collecting hot topic data from on-site and off-site, some data cleaning processing can also be performed, which can mainly be divided into the following aspects:
Negative hot topic data filtering: If the hot topic data information contains negative emotions (such as negative comments, crisis events, etc.), this hot topic data can be discarded, the evaluation result recorded, and subsequent analysis performed.
Hot topic fatigue detection: Check whether the hot topic data information is highly repetitive with recently published content. If so, the publication of content corresponding to this hot topic data can be abandoned, or consideration can be given to differentiating the content.
Account matching degree filtering: Compare the current hot topic data information with the account persona positioning associated with the current entity. If there is a clear inconsistency between the content and the account persona positioning (such as target audience, brand tone, etc.), this content can be discarded.
Risk control tagging and filtering: The collected hot topic data can be automatically tagged for risk control to perform risk control.

After performing data cleaning processing on the hot topic data, specific content generation is then carried out. In particular, in order to improve the quality of content generation, multiple content types can be predefined, and detailed meanings, publishing purposes, etc., can be provided for each content type. This information can serve as a prompt for the large model, so that the large model can generate content in a more directional and targeted manner, thereby improving the quality of the specifically generated content.

For example, when a certain cross-border e-commerce platform is the current target entity, the specifically defined content types and their corresponding detailed meanings may include:
Product recommendation: In response to hot topic information, products related to the hot topic can be recommended based on user needs and interests. For example, if the current hot topic is environmental protection, some sustainable development products can be recommended, such as eco-friendly bags, goods made from renewable materials, or green cleaning products;
Activity giveaway: Combined with the current hot topic, a related giveaway activity can be designed to attract user participation and enhance interactivity. For example, if a recent hot topic is the release of a popular movie, peripheral products related to the movie theme can be offered as prizes;
Brand promotion: When conducting brand promotion, hot events can be used to enhance brand awareness and reputation. For example, when society is paying attention to a certain public welfare activity, it can be combined with the brand's social responsibility to publish promotional content about participating in the activity, to showcase the current entity's values and mission;
Hot post rewriting: Combined with current hot topics, the content of some popular posts can be rewritten or summarized to attract users' attention and participation. For example, if there has been a heated discussion about a certain TV series recently, the hot post can be rewritten as “Who is your favorite character?” and users can be encouraged to share their views and experiences;
Creative voting: A creative voting activity can be launched around a hot topic, allowing users to participate in selection or voting. For example, during a popular sports event, a vote for “Who do you think will win the championship?” can be conducted, or during a popular festival like Halloween, a “Best Creative Costume” vote can be organized to increase user interaction and participation;
Industry dynamics: Combined with industry dynamics related to hot topics, focus on key events or trends to provide users with timely information updates. For example, if a popular technology product has been released recently, a related industry analysis article can be written to interpret the product's impact on the market;
Knowledge sharing: Share professional knowledge around hot topics to provide users with valuable content. For example, if the current hot topic is healthy eating, a guide on how to choose healthy food can be written, or an online lecture can be organized, inviting experts to share relevant knowledge, to enhance user trust and brand image.

Certainly, in specific implementation, other content types may also be included. In addition, different content types can also be defined for different types of entities, which will not be enumerated here.

When multiple content types are predefined, an AI large model for decision-making can also be provided. Through this AI large model, the collected hot topic data can be understood to determine a suitable content type, as well as a suitable country/region, target population, industry, and/or commodity category. At the same time, at least one target sub-account related to the target country/region, target population, industry, and/or commodity category can also be determined. That is to say, for the collected hot topic data, through the understanding and analysis of the AI large model, it can be determined what type of content it is suitable to be published as, and in which country/region, for which population, etc., it is suitable to be published, and thus it can be determined through which sub-accounts it should be published. For example, assuming a certain piece of hot topic data is related to the “nail art” industry, and this hot topic data comes from a hot-selling list of an e-commerce platform in a certain country/region, then it can be determined that this hot topic data is suitable for publication in that country/region to the population related to “nail art”. Therefore, among the sub-accounts under that country/region, a sub-account related to that industry can be selected, and so on.

After determining the specific sub-accounts on which publishing is required, corresponding content can be generated. In particular, since different sub-accounts have their own account persona positioning, even when facing the same population and industry, different sub-accounts may also have their own different styles, tones, content expression habits, and so on. Therefore, in order to make the generated content more diverse and reflect the characteristics of specific sub-accounts, respective corresponding AI large models can also be pre-trained for each specific sub-account (for example, this can be achieved through methods such as a benchmark model+multiple LoRA (Low-Rank Adaptation of Large Language Models), where multiple LoRA models are used to achieve adaptation with each sub-account, respectively, and so on). In this case, since the hot topic data has been collected previously, the content type has been determined, and the sub-accounts on which to publish have been determined, the AI large models pre-trained for these target sub-accounts can generate content of the corresponding type, and can also determine information such as the publishing time according to the corresponding publishing time strategy. In particular, since specific sub-accounts usually correspond to their own country/region attributes, the language of the corresponding country/region can be used when generating the content.

Specifically, during the process of content generation via the AI large model, it can be performed according to the content publishing strategy corresponding to the specific sub-account. The content publishing strategy can be used to define the content style and content matching degree suitable for the specific sub-account, and the AI large model can generate content according to the specific strategy. Certainly, at the beginning of a project, it may be difficult to accurately know what kind of style is suitable for each sub-account. Therefore, what needs to be done is to generate as many various types of content as possible, and then, during the specific publishing process, adjust the specific content publishing strategy based on the feedback from user interactions with the content. For example, the features that need to be adjusted and tried are as follows:
Hot topic data quality: Collect and connect to as many different data sources as possible, and mark the hot topic source channel and hot topic timeliness as basic features.
Content type: Generate as many various types of content templates as possible, such as product recommendation posts, giveaways, brand promotions, hot post rewrites, polls, and so on. Multiple prompt templates can be prepared for each type and marked as corresponding features.
Commodity quality: In cases where commodity recommendations are needed in the generated content, to prevent quality problems caused by the massive number of commodities on the site, industry operation personnel can first manually select high-quality commodity pools of various types, such as new product pools, best-selling pools, industry pools, and so on.

The generated content can be ranked based on manual scoring by SNS operation personnel. Through statistical learning methods, the basic weights of various features can be obtained. In subsequent intelligent posting plans, these weights can be used to calculate a content quality score and perform ranking, preliminarily forming a content publishing strategy suitable for the account.

Specifically, during the process of content generation, it is also possible to combine the characteristics of the current target entity itself and add some content related to the entity to the content. For example, if the specific target entity is a cross-border commodity information service platform, as described above, one type of content can include commodity recommendations. At this time, content related to the specific recommended commodity can be added to the generated content. Specifically, after collecting the hot topic data and determining to generate commodity recommendation content, a target commodity related to the hot topic data and related display materials of the target commodity can also be determined from the commodity information service platform, including information such as commodity images, titles, and attributes. Afterwards, the related display materials of the target commodity can be provided to the AI large model trained for the target sub-account, so that the AI large model generates text content related to commodity recommendations based on the hot topic data, and assembles it with the display materials into content to be published of the commodity recommendation type.

In addition, when generating content for the sub-account through the AI large model, adaptation processing can also be performed on the generated content according to the SNS network corresponding to the target sub-account, to adapt to the SNS network's content style, format, specifications, required interactive elements, and/or user preferences. This not only includes adjusting the tone and style of the text content, but can also involve image size, format, and interactive elements required by different platforms, such as polls, Q&As, and so on, to ensure that the finally published content can effectively attract users' attention and participation on various SNS channels. For example, a certain SNS network supports the use of tags to make published content more easily discovered by users, which is equivalent to providing multiple ways to reach a larger audience and increase interaction accumulation. Based on this situation, a set of the currently most popular tags can be provided, and the large model can be used to find the tags that best fit the currently generated content and integrate them into the content.

In particular, assuming that a certain SNS network requires that published content must include an image, then during the content generation process, relevant image materials can be obtained at the same time as generating the text content, and assembled into the final content to be published. In particular, regarding the image part, it can be queried through a relevant image library (for example, the commodity image library of an e-commerce platform, and so on), or, it can also be directly generated by an AI large model, and so on.

In addition, some SNS networks may support publishing a plurality of different content formats. For example, a certain SNS network may support users to publish “works” (e.g., permanent posts) and also to publish “stories” (e.g., temporary content). In particular, “works” usually have a clear creative purpose and form, aiming to express the author's emotions, thoughts, values, and so on, with an emphasis on artistry and aesthetics. “Works” often require the author to have deep thought and rich imagination, using detailed, vivid descriptions and metaphors, and paying attention to techniques such as language, rhythm, and cadence. “Stories”, on the other hand, focus more on trivial matters and ordinary events in life, recording the bits and pieces of life, without emphasizing artistry and aesthetics. Daily records can be casual and impromptu, not necessarily having a clear creative purpose, but more for recording real scenes and feelings in life. In addition, there will also be differences in display duration. Published “works” usually exist permanently unless deliberately deleted by the author, while published “stories” usually exist for a certain period of time (for example, 24 hours), and will be hidden when the time is up, visible only to the author. The display audience is also different. “Works” are visible to all users on the network, while “stories” can usually only be viewed by “friends” who follow the account after entering the account's personal homepage. Based on the above situation, when performing SNS network adaptation processing on the generated content, the generated content can also be rewritten in multiple ways to generate content corresponding to a plurality of content formats, and published in different content formats respectively. For example, content suitable for publishing in the form of a work can be generated, and content suitable for publishing in the form of a story can also be generated, and so on. Alternatively, after generating content suitable for publishing as a work, the large model can also be used to modify the current content to conform to the style of a “story”, including shortening the length of the text to make it more immediate and visually impactful, and so on.

It should be noted here that, in the case where a commodity information service system is the posting entity, it may often be necessary to add specific commodity information to the content. If commodity information is directly added to content in the form of a work, there may be problems such as the frequency cannot be too high, otherwise it may be subject to the rule restrictions of the SNS platform. In this case, one can also choose to rewrite the “work” content into “story” content, and then associate specific commodity information in the “story” content, and so on.

In the content publishing stage, a series of steps can be followed to ensure the security and effectiveness of the content. First, anti-AI detection is performed to determine whether the generated content meets the platform's security standards. Next, risk control verification is performed to ensure that the published content will not cause legal or ethical problems, thereby reducing risks. After that, the potential performance of the content can be evaluated based on an algorithmic AI score. On this basis, a detailed publishing plan can be formulated by AI, selecting the optimal publishing time to maximize the exposure rate and effectiveness of the content. Finally, after manual scoring to reconfirm the quality and potential for dissemination of the content, it is formally published to various SNS platforms to ensure that the content successfully reaches the target audience. This systematic publishing process can effectively enhance the value of the content and the user's interactive experience.

In addition, during the distribution stage, direct feedback from user behavior data on the platform (such as number of views, interactions, likes, etc.) can be used to further guide and improve the posting strategy and quality, including:
(1) Optimizing the strategy model based on EE (Exploration & Exploitation, where exploration is developing unknown areas, and exploitation is utilizing known states).

Test different content publishing strategies, including different content styles, content types, publishing times, and frequencies. At this stage, attention can be paid to the diversity of user behavior, trying to discover content forms or publishing times that have not yet been fully utilized. And based on previous user feedback and data analysis, determine the best-performing content styles and content types, and reuse and optimize them extensively to maximize user interaction and participation.
(2) Optimization of publishing time and frequency.

By analyzing user active time periods, the time for publishing that can achieve the best interaction effect can be understood. At the same time, different publishing frequencies can be tested to ensure that the best time and frequency for post publishing are obtained without excessively disturbing users.
(3) Optimization of text quality.

Based on user effect feedback, high-quality content of the same type from the same account can be collected and the AI posting text generation model for the corresponding strategy can be continuously trained, and the improvement effect through methods such as manual scoring and A/B testing can be confirmed.
(4) Optimization of commodity quality.

In the case where a commodity information service system is the posting entity, in addition to estimating commodity quality through on-site commodity model scoring, questionnaire posts can also be initiated to directly let users provide feedback on their preference for commodities, and commodities in the commodity pool can be directly replaced or eliminated based on the voting data.
(5) Improvement of account persona.

User behaviors such as browsing and interaction can be continuously monitored and analyzed, and they can be combined with user data fed back from the platform to continuously improve the user preferences and persona of the population corresponding to the account, which will promote the quality of content production and the iterative upgrade of strategies.

In an optional implementation, in addition to generating posting content through the AI large model, the collaborative relationship between different accounts can also be managed to drive traffic between different accounts, and so on. Specifically, in one approach, the quality of the content generated by the AI large model for the sub-account can be judged. If a preset condition is met, the country/region account and/or the main account of the country/region to which the sub-account belongs can be mentioned in the generated content, so as to realize interaction between the sub-account and the country/region account and/or the main account. That is to say, after the AI large model generates post content for a certain sub-account, if the quality of the post content is relatively good, the specific country/region account can also be mentioned in its content by means of “@country/region account”, and so on. For example, assuming that the content published by a certain sub-account is related to a certain commodity, it can be reflected in the content that “If you want to know more details about this commodity, please go to @country/region account”, and so on. If a user is interested in this, they can click the country/region account link in the content to enter the homepage of the country/region account for viewing, thereby achieving traffic diversion to the country/region account, and so on.

In another approach, when managing the collaborative relationship between different accounts, a sub-account can also repost some of the content published by the country/region account of the country/region to which it belongs. For example, if a certain country/region account publishes content about a platform event, the sub-accounts associated with that country/region can repost the content, so that the content published by the country/region account can more accurately reach certain segmented populations in vertical domains through the sub-accounts.

Furthermore, “mutual following and reposting” between different sub-accounts can also be realized, so that the content published by a sub-account can also reach more segmented populations by being reposted by other sub-accounts, and so on. Certainly, during the process of “mutual following and reposting” between sub-accounts, mutual reposting of content between sub-accounts in different industries can be avoided as much as possible to avoid affecting the user experience.

The foregoing mainly introduces the solution provided by the embodiments of the present application from the perspective of intelligent posting. In practical applications, in addition to intelligent posting, intelligent replies can also be realized through an AI large model. For example, after a certain account publishes a piece of content, some users may comment on the content, and may raise some questions in the comments, for example, how to buy a certain commodity, and so on. In addition, some users, after viewing the content published by a certain account, may also send private messages to the account to ask certain questions. In the embodiments of the present application, where there are numerous sub-accounts, the volume of user comment content or private message content may also be very high. Therefore, after an account in the account matrix system receives comment content or private message content input by a user for the published content, an AI large model can also be used to generate reply content for the comment content or private message content.

In addition, besides replying to users' comment content or private message content for accounts within the system, since mutual following and reposting between accounts within the system can also be realized, it is also possible to provide intelligent replies to followed accounts after they publish content. For example, a certain country/region account of a certain entity has sub-accounts A and B. These two accounts follow each other because their involved industry domains are related. After sub-account A publishes a piece of content, an AI large model can also generate reply content to the content published by account A in the tone of sub-account B, and so on.

Furthermore, accounts within the system can also follow some popular accounts outside the system, for example, influential accounts in a certain industry, and so on. By following these popular accounts, the exposure of accounts within the system can be increased by promptly commenting on the content published by the popular accounts.

Alternatively, in addition to the content published by some well-known popular accounts that may have a relatively high degree of popularity, the content published by some unknown accounts may also unexpectedly become a hot topic. For this type of content, accounts within the system can also promptly publish comment content. To achieve this goal, a keyword and/or topic monitoring mechanism can also be set up to capture and analyze hot topics and discussion trends on SNS platforms in real time. Through the contextual understanding technology of the AI large model, the sub-accounts in the specific account matrix system that are related to the topic or discussion trend are identified, and replies that are highly relevant to the discussion topic are generated to guide users to the sub-account for more in-depth interaction and understanding. For example, if there are several popular keywords related to the nail art industry, one can monitor whether there are hot posts published under a certain keyword (for example, a surge in the number of likes, etc.). If so, an AI large model can also intervene to publish comment content for this type of hot post through sub-accounts in related industries within the system, and so on.

Specifically, during the process of intelligent reply posting, the quality of the intelligent reply posts can also be evaluated to gradually improve the quality of intelligent reply posts. However, during the intelligent posting process, the quality of the content can be judged very intuitively from user behaviors such as browsing/interaction. But for reply posts, this data cannot be directly obtained. Therefore, the core solution is to classify the user's intentions through an AI large model, establish different user behavior feedback standards according to different classifications, and then gradually optimize and iterate. For example, the proportion of user reply post types for a certain cross-border commodity information service system is as follows:
Inquiry/complaint: 50%
Emotional Venting: 30%
Sharing: 10%

Taking the inquiry type as an example, after replying to a user's inquiry, feedback on the reply can be obtained from the user through private messages, and so on. The adoption rate is calculated based on the feedback, which is used to tag the AI reply content, thereby promoting the continuous upgrading of the AI large model and prompt strategy, and improving the quality of reply posts.

For the emotional venting type, AI can be used to generate emotionally soothing reply content. Subsequently, it can be judged whether the reply strategy is successful by observing whether the user complains a second time.

It should be noted that the AI large model used in the embodiments of the present application can be based on the existing content generation capabilities of existing large language models. After cleaning information such as on-site and off-site data and script templates, it is input to train a model that meets the needs of the specific entity's site, enabling it to generate content that conforms to the characteristics of different platforms and brand tonality.

In summary, through the embodiments of the present application, an account operation and management service can be provided for entities with cross-border account operations. Through this service, an SNS account matrix system can be constructed for a specific entity. The matrix can include a main account registered by the entity on an SNS network, and can also include country/region accounts registered for a plurality of countries/regions. Each country/region account can also have at least one sub-account. Such a sub-account can be an account directly registered by the current entity on the SNS network, or it can be an account registered by another entity on the SNS network and authorized to the current entity for operational management and hosting; wherein, such sub-accounts have their own account persona positioning in terms of facing specific segmented populations, industries, and/or commodity categories. On the basis of constructing the above-mentioned account matrix system, an Artificial Intelligence (AI) large model can also be used to perform automated content generation and publishing according to the content publishing strategies corresponding to the accounts in the account matrix system; wherein, the content publishing strategy corresponding to a sub-account can be related to the account persona positioning of the account, so that the content, time, and so on published by a specific sub-account are all related to the specific account persona positioning, achieving refined operation for each user group, and enabling the same sub-account to obtain continuous attention from the corresponding population.

In an optional implementation, the AI large model can also be used to perform collaborative interaction processing between different accounts in the account matrix system, including mentioning the country/region account and/or the main account of the country/region to which a sub-account belongs in the content generated for the sub-account; or, reposting some of the content published by the country/region account of the country/region to which a sub-account belongs through the sub-account; or, performing mutual following and/or mutually reposting content published by each other between sub-accounts with the same or related account persona positioning, and so on. Through this kind of interaction between accounts, the effect of widely displaying the brand image to users can be formed, and the operating cost of the accounts can be reduced.

In addition, intelligent replies can also be realized through the AI large model, including replying to users' comment or private message content, or intelligently replying to content published by popular accounts in the industry, or, by setting up a keyword and/or topic monitoring mechanism, capturing and analyzing hot topics and/or discussion trend content in the SNS network in real time, and determining the sub-accounts in the account matrix system that are related to the hot topics and/or discussion trend content, and generating content for the sub-account to comment on the hot topics and/or discussion trend content through the AI large model.

### Embodiment Two

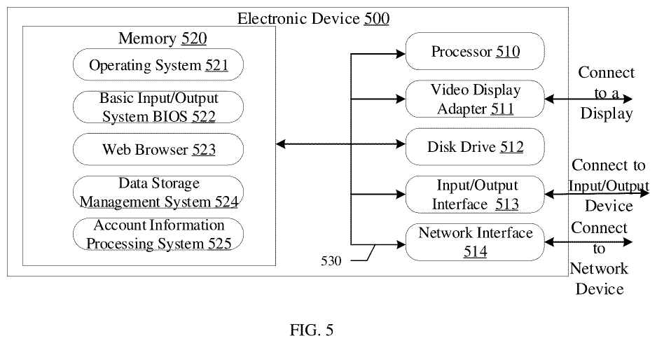

Embodiment Two corresponds to the aforementioned Embodiment One. From the perspective of the user side (for example, the operation personnel of the target entity, and so on), a method for processing SNS account information is provided. Referring to FIG. 4, the method may include:
S401: Receiving, through a target interface, account configuration information submitted for a target entity, the account configuration information including a main account registered by the target entity on an SNS network, a plurality of country/region accounts registered for a plurality of different countries/regions respectively, and at least one sub-account associated under each country/region account, the sub-account including an account registered by the target entity on the SNS network, and/or, an account registered by another entity on the SNS network and authorized to the target entity for operational management and hosting; the sub-account having its own account persona positioning in terms of facing a specific segmented population, industry, and/or commodity category;
S402: Constructing an SNS account matrix system for the target entity according to the account configuration information, so as to perform automated content generation and publishing through an AI large model according to content publishing strategies corresponding to the accounts in the account matrix system; wherein, the content publishing strategy corresponding to the sub-account is related to the account persona positioning of the account.

In particular, the AI large model can also be used to perform collaborative interaction processing between different accounts.

For the parts not detailed in this Embodiment Two, reference can be made to the descriptions in Embodiment One and other parts of this specification, which will not be repeated here.

It should be noted that the embodiments of the present application may involve the use of user data. In practical applications, user-specific personal data can be used in the solutions described herein within the scope permitted by applicable laws and regulations, provided that the requirements of the applicable laws and regulations of the country where it is located are met (for example, explicit user consent, effective notification to the user, etc.).

Corresponding to Embodiment One, an embodiment of the present application also provides an apparatus for providing a Social Networking Service account operation and management service. The apparatus is applied to an account operation and management service system and includes:
an account matrix system determination unit, configured to determine a Social Networking Service (SNS) account matrix system of a target entity, the account matrix system including a main account registered by the target entity on an SNS network, a plurality of country/region accounts registered for a plurality of different countries/regions respectively, and at least one sub-account associated under each country/region account, the sub-account including an account registered by the target entity on the SNS network, and/or, an account registered by another entity on the SNS network and authorized to the target entity for operational management and hosting; the sub-account having its own account persona positioning in terms of facing a specific segmented population, industry, and/or commodity category;
an account management service unit, configured to perform automated content generation and publishing through an Artificial Intelligence (AI) large model according to content publishing strategies corresponding to the accounts in the account matrix system; wherein, the content publishing strategy corresponding to the sub-account is related to the account persona positioning of the account.

In particular, when the account management service unit generates content for the sub-account through the AI large model, it is specifically configured to:
collect hot topic data;
understand the hot topic data through an AI large model for decision-making, to determine a suitable content type, as well as a suitable country/region, target population, industry, and/or commodity category, and determine at least one target sub-account related to the target country/region, target population, industry, and/or commodity category;
have an AI large model pre-trained for the target sub-account generate content of a corresponding type for the target sub-account, and determine a publishing time according to a corresponding publishing time strategy.

Specifically, the target entity includes a cross-border commodity information service platform; the content type includes a commodity recommendation type;

At this time, the apparatus may further include:
a display material acquisition unit, configured to determine a target commodity related to the hot topic data and related display materials of the target commodity from the commodity information service platform;
a display material providing unit, configured to provide the related display materials of the target commodity to the AI large model trained for the target sub-account, for use in generating text content related to commodity recommendations based on the hot topic data, and assembling it with the display materials into content to be published of the commodity recommendation type.

In addition, when the account management service unit specifically generates content for the sub-account through the AI large model, it is further configured to:
after generating content of a corresponding type for a target sub-account, perform adaptation processing on the generated content according to the SNS network corresponding to the target sub-account, to adapt to the SNS network's content style, format, specifications, required interactive elements, and/or user preferences.

In addition, it can also be configured to: when performing the adaptation processing, if the SNS network supports a plurality of different content formats, rewrite the generated content in a plurality of ways to generate content corresponding to the plurality of content formats, and publish them in the different content formats respectively.

Furthermore, the account management service unit is further configured to:
update the content publishing strategy corresponding to the sub-account based on user interaction feedback on the content published in the account.

Specifically, the account management service unit is further configured to:
perform collaborative interaction processing between different accounts in the account matrix system through the AI large model.

In particular, specifically, when performing collaborative interaction processing between different accounts in the account matrix system, it can be configured to:
judge the quality of the content generated by the AI large model for the sub-account, and if a preset condition is met, mention the country/region account and/or the main account of the country/region to which the sub-account belongs in the generated content, so as to realize interaction between the sub-account and the country/region account and/or the main account;
alternatively, repost some of the content published by the country/region account of the country/region to which the sub-account belongs through the sub-account.
alternatively, perform mutual following and/or mutually repost content published by each other between sub-accounts with the same or related account persona positioning.

In addition, the apparatus may further include:
an automatic reply unit, configured to, after an account in the account matrix system receives comment content or private message content input by a user for published content, use an AI large model to generate reply content for the comment content or private message content.
a comment content generation unit, configured to have a sub-account in the account matrix system follow a well-known account outside the system in a corresponding industry or domain, and after the well-known account outside the system publishes content, use an AI large model to generate comment content for the published content.

Alternatively, by setting up a keyword and/or topic monitoring mechanism, hot topics and/or discussion trend content in the SNS network can be captured and analyzed in real time, and the sub-accounts in the account matrix system that are related to the hot topics and/or discussion trend content can be determined, and content for the sub-account to comment on the hot topics and/or discussion trend content can be generated through an AI large model.

Corresponding to Embodiment Two, an embodiment of the present application also provides an SNS account information processing apparatus, the apparatus may include:
a configuration information receiving unit, configured to receive, through a target interface, account configuration information submitted for a target entity, the account configuration information including a main account registered by the target entity on an SNS network, a plurality of country/region accounts registered for a plurality of different countries/regions respectively, and at least one sub-account associated under each country/region account, the sub-account including an account registered by the target entity on the SNS network, and/or, an account registered by another entity on the SNS network and authorized to the target entity for operation hosting; the sub-account having its own account persona positioning in terms of facing a specific segmented population, industry, and/or commodity category;
an account matrix system construction unit, configured to construct an SNS account matrix system for the target entity according to the account configuration information, so as to perform automated content generation and publishing through an AI large model according to content publishing strategies corresponding to the accounts in the account matrix system; wherein, the content publishing strategy corresponding to the sub-account is related to the account persona positioning of the account.

In particular, the AI large model can also be used to perform collaborative interaction processing between different accounts.

In addition, an embodiment of the present application also provides a computer-readable storage medium, on which a computer program is stored, wherein when the program is executed by a processor, it implements the steps of the method according to any one of the foregoing method embodiments.

And an electronic device, including:
one or more processors; and
a memory associated with the one or more processors, the memory being used to store program instructions, wherein when the program instructions are read and executed by the one or more processors, the steps of the method according to any one of the foregoing method embodiments are performed.

A computer program product, including a computer program/computer-executable instructions, wherein when the computer program/computer-executable instructions are executed by a processor in an electronic device, the steps of the method described in the foregoing method embodiments are implemented.

In particular, FIG. 5 exemplarily shows the architecture of an electronic device, which may specifically include a processor 510, a video display adapter 511, a disk drive 512, an input/output interface 513, a network interface 514, and a memory 520. The aforementioned processor 510, video display adapter 511, disk drive 512, input/output interface 513, and network interface 514 can be communicatively connected with the memory 520 through a communication bus 530.

In particular, the processor 510 can be implemented as a general-purpose Central Processing Unit (CPU), a microprocessor, an Application Specific Integrated Circuit (ASIC), or one or more integrated circuits, and is used to execute relevant programs to implement the technical solutions provided by the present application.

The memory 520 may be implemented in the form of a ROM (Read Only Memory), a RAM (Random Access Memory), a static storage device, a dynamic storage device, or the like. The memory 520 may store an operating system 521 for controlling the operation of the electronic device 500, and a basic input/output system (BIOS) 522 for controlling low-level operations of the electronic device 500. In addition, it may also store a web browser 523, a data storage management system 524, and an account information processing system 525, and so on. The aforementioned account information processing system 525 may be the application program that specifically implements the operations of the foregoing steps in the embodiments of the present application. In summary, when the technical solutions provided by the present application are implemented through software or firmware, the relevant program code is stored in the memory 520 and is retrieved and executed by the processor 510.

The input/output interface 513 is configured to connect to an input/output module to implement information input and output. The input/output module may be configured as a component in the device (not shown in the figure), or may be externally connected to the device to provide corresponding functions. In particular, input devices may include a keyboard, a mouse, a touchscreen, a microphone, various types of sensors, etc., and output devices may include a display, a speaker, a vibrator, an indicator light, etc.

The network interface 514 is configured to connect to a communication module (not shown in the figure) to implement communication between the device and other devices. In particular, the communication module may implement communication through a wired method (e.g., USB, network cable, etc.), or may implement communication through a wireless method (e.g., mobile network, WIFI, Bluetooth, etc.).

The bus 530 includes a channel that transmits information among the various components of the device (e.g., the processor 510, the video display adapter 511, the disk drive 512, the input/output interface 513, the network interface 514, and the memory 520).

It should be noted that, although the aforementioned device only shows the processor 510, the video display adapter 511, the disk drive 512, the input/output interface 513, the network interface 514, the memory 520, the bus 530, etc., in the specific implementation process, the device may also include other components necessary for normal operation. In addition, a person skilled in the art can understand that the aforementioned device may also only include the components necessary to implement the solutions of the present application, and does not necessarily have to include all the components shown in the figure.

From the description of the above embodiments, a person skilled in the art can clearly understand that the present application can be implemented using software executing on a necessary general-purpose hardware platform. Based on this understanding, the technical solution of the present application in essence, or the part that contributes to the prior art, can be embodied in the form of a software product. The computer software product can be stored in a storage medium, such as a ROM/RAM, a magnetic disk, an optical disc, etc., and includes a plurality of instructions to cause a computer device (which may be a personal computer, a server, or a network device, etc.) to execute the methods described in the various embodiments of the present application or certain parts of the embodiments.

The various embodiments in this specification are described in a progressive manner. The same or similar parts among the various embodiments can be referred to each other. Each embodiment focuses on describing the differences from other embodiments. In particular, for the system or system embodiments, since they are basically similar to the method embodiments, the description is relatively simple, and for relevant parts, reference can be made to the partial description of the method embodiments. The systems and system embodiments described above are merely illustrative. The units described as separate components may or may not be physically separate, and the components displayed as units may or may not be physical units, that is, they may be located in one place, or may be distributed to multiple network units. Some or all of the modules can be selected according to actual needs to achieve the objectives of the solutions of the embodiments. A person of ordinary skill in the art can understand and implement them without inventive effort.

The method for providing a Social Networking Service account operation and management service and the electronic device provided by the present application have been described in detail above. Specific examples have been used in this document to explain the principles and implementation methods of the present application. The description of the above embodiments is only for helping to understand the method of the present application and its core ideas. At the same time, for a person of ordinary skill in the art, based on the ideas of the present application, there will be changes in the specific implementation methods and application scope. In summary, the content of this specification should not be construed as a limitation on the present application.

What is claimed is:

1. A method for providing a Social Networking Service account operation and management service, applied to an account operation and management service system, the method comprising:
determining a Social Networking Service (SNS) account matrix system of a target entity, wherein the account matrix system comprises a main account registered by the target entity in an SNS network, a plurality of country/region accounts respectively registered for a plurality of different countries/regions, and at least one sub-account associated under each country/region account, wherein the sub-account comprises an account registered by the target entity in the SNS network, and/or, an account registered by another entity in the SNS network and authorized to the target entity for operational management; wherein the sub-account has its own respective account persona positioning directed to a specific segmented population, industry, and/or commodity category; and
performing automated content generation and publishing through an Artificial Intelligence (AI) large model according to a content publishing strategy corresponding to a sub-account in the account matrix system; wherein, the content publishing strategy corresponding to the sub-account is related to the account persona positioning of the sub-account.

2. The method according to claim 1, wherein performing automated content generation and publishing through an Artificial Intelligence (AI) large model according to a content publishing strategy corresponding to a sub-account in the account matrix system comprises:
collecting hot topic data;
understanding the hot topic data through an AI large model for decision-making to determine a suitable content type, and a suitable country/region, target population, industry, and/or commodity category, and determining at least one target sub-account related to the target country/region, target population, industry, and/or commodity category; and
generating content of a corresponding type for the target sub-account by an AI large model pre-trained for the target sub-account, and determining a publishing time according to a corresponding publishing time strategy.

3. The method according to claim 2, wherein,
the target entity comprises a cross-border commodity information service platform;
the content type comprises a product recommendation type; and the method further comprises:
determining a target commodity related to the hot topic data from the commodity information service platform, and relevant display materials of the target commodity; and
providing the relevant display materials of the target commodity to the AI large model trained for the target sub-account to generate text content related to product recommendation based on the hot topic data; and assembling the text content and the display materials to form content to be published of the product recommendation type.

4. The method according to claim 2, wherein the method further comprises:
after generating the content of the corresponding type for the target sub-account, adapting the generated content to a content style, format, specification, required interactive elements, and/or user preferences of an SNS network corresponding to the target sub-account.

5. The method according to claim 4, wherein,
when performing the adapting, if the SNS network supports a plurality of different content formats, rewriting the generated content in a plurality of ways to generate content corresponding to the plurality of different content formats, and publishing the content separately in the plurality of different content formats.

6. The method according to claim 1, wherein the method further comprises:
updating the content publishing strategy corresponding to the sub-account based on interaction feedback from users on content published in the account.

7. The method according to claim 1, wherein the method further comprises:
performing collaborative interaction processing between different accounts in the account matrix system through the AI large model.

8. The method according to claim 7, wherein,
the performing collaborative interaction processing between different accounts in the account matrix system comprises:
determining a quality of content generated by the AI large model for the sub-account, and if a preset condition is met, mentioning a country/region account of a country/region to which the sub-account belongs and/or the main account in the generated content, to implement interaction between the sub-account and the country/region account and/or the main account.

9. The method according to claim 7, wherein,
the performing collaborative interaction processing between different accounts in the account matrix system comprises:
reposting, by the sub-account, a portion of content published by a country/region account of a country/region to which the sub-account belongs.

10. The method according to claim 7, wherein,
the performing collaborative interaction processing between different accounts in the account matrix system comprises:
performing mutual following between sub-accounts with the same or related account persona positioning, and/or mutually reposting content published by each other.

11. The method according to claim 1, wherein the method further comprises:
after an account in the account matrix system receives comment content or private message content input by a user for published content, generating reply content for the comment content or the private message content using the AI large model.

12. The method according to claim 1, wherein the method further comprises:
following, by a sub-account in the account matrix system, a well-known account outside the account matrix system in a corresponding industry or domain, and after the well-known account outside the account matrix system publishes content, generating comment content for the published content using the AI large model.

13. The method according to claim 1, wherein the method further comprises:
by setting a keyword and/or topic monitoring mechanism, capturing and analyzing in real time hot topics and/or discussion trend content in the SNS network, and determining a sub-account in the account matrix system that is related to the hot topics and/or discussion trend content, and generating, through the AI large model, content for the sub-account to comment on the hot topics and/or discussion trend content.

14. A non-transitory computer-readable storage medium configured with instructions executable by one or more processors to cause the one or more processors to perform the method of claim 1.

15. An electronic device comprising:
one or more processors; and
one or more computer-readable memories coupled to the one or more processors and having instructions stored thereon that are executable by the one or more processors to perform the method of claim 1.

16. An Social Networking Service (SNS) account information processing method, comprising:
receiving, through a target interface, account configuration information submitted for a target entity, wherein the account configuration information comprises a main account registered by the target entity in an SNS network, a plurality of country/region accounts respectively registered for a plurality of different countries/regions, and at least one sub-account associated under each country/region account, wherein the sub-account comprises an account registered by the target entity in the SNS network, and/or, an account registered by another entity in the SNS network and authorized to the target entity for operational management; wherein the sub-account has its own respective account persona positioning directed to a specific segmented population, industry, and/or commodity category; and
constructing an SNS account matrix system of the target entity based on the account configuration information, so as to perform automated content generation and publishing through an AI large model according to a content publishing strategy corresponding to a sub-account in the account matrix system; wherein, the content publishing strategy corresponding to the sub-account is related to the account persona positioning of the sub-account.

17. The method according to claim 16, wherein,
the AI large model is further configured to perform collaborative interaction processing between different accounts.

18. A non-transitory computer-readable storage medium configured with instructions executable by one or more processors to cause the one or more processors to perform the method of claim 16.

19. An electronic device comprising:
one or more processors; and
one or more computer-readable memories coupled to the one or more processors and having instructions stored thereon that are executable by the one or more processors to perform the method of claim 16.

20. An Social Networking Service (SNS) account operation and management service system comprising:
an account matrix system determination unit, configured to determine an SNS account matrix system of a target entity, the account matrix system including a main account registered by the target entity on an SNS network, a plurality of country/region accounts registered for a plurality of different countries/regions respectively, and at least one sub-account associated under each country/region account, the sub-account including an account registered by the target entity on the SNS network, and/or, an account registered by another entity on the SNS network and authorized to the target entity for operational management; the sub-account having its own account persona positioning in terms of facing a specific segmented population, industry, and/or commodity category;
an account management service unit, configured to perform automated content generation and publishing through an Artificial Intelligence (AI) large model according to content publishing strategies corresponding to the accounts in the account matrix system;
wherein, the content publishing strategy corresponding to a sub-account is related to the account persona positioning of the sub-account.
